(19) United States
(12) Patent Application Publication
(10) Pub. No.: US 2025/0356613 A1
(43) Pub. Date: Nov. 20, 2025

(54) METHODS AND SYSTEMS FOR MARITIME COMPLIANCE VERIFICATION USING COMPUTER VISION

(71) Applicant: SAUDI ARABIAN OIL COMPANY, Dhahran (SA)

(72) Inventors: Abdullah M. Anazi, Khobar (SA); Omar A. Abdullatif, Dhahran (SA); Waleed S. Saeed, Dhahran (SA); Abdullah A. Dossary, Khobar (SA)

(73) Assignee: SAUDI ARABIAN OIL COMPANY, Dhahran (SA)

(21) Appl. No.: 18/665,275

(22) Filed: May 15, 2024

(51) Int. Cl. G06V 10/44; G06T 5/20; G06T 5/50; G06T 5/70; G06T 7/13; G06V 10/25; G06V 10/764

(52) U.S. Cl. CPC G06V 10/44; G06T 5/20; G06T 5/50; G06T 5/70; G06T 7/13; G06V 10/25; G06V 10/764; G06T 2207/20084; G06T 2207/20224

(57) ABSTRACT

Methods and systems for determining maritime compliance are disclosed. The method may include acquiring, using one or more image capture devices, a raw application image and processing the raw application image to produce a processed image. Using a trained machine learning network, the method further includes predicting one or more labeled features in the processed image and determining a class of each of the one or more labeled features forming a set of determined classes. The method further includes determining, with the trained machine learning network, maritime compliance based, at least in part, on whether a first feature of the one or more labeled features is non-compliant based on the determined class of the first feature, and generating one or more alerts regarding maritime compliance based on a determination that the first feature is non-compliant.

### BACKGROUND

A terminal is a facility where vessels load and unload cargo or passengers, and where various activities related to maritime transportation take place. In general, terminals are located along coastlines or major waterways and serve as crucial points of connection between land-based transportation networks (e.g., railways and highways) and sea-based transportation (e.g., shipping routes). Typically, a mandatory Vessel Traffic Management System (VTMS) is used during operation to monitor and manage vessel traffic in a terminal. For example, a VTMS may provide information on channels, port conditions, and the movement of vessels. In addition, a VTMS may advise on port rules and prioritize vessel movements, thus helping reduce traffic congestion in a terminal. However, traditional VTMS systems only detect the presence and movements of vessels and do not check for maritime and safety compliance. This lack of compliance results in the many injuries that occur in terminal facilities around the world yearly. Accordingly, there exists a need to verify that objects and people are complying with maritime and safety regulations at all times in terminals and marine ports.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Embodiments disclosed herein generally relate to a method of training a machine learning network. The method includes obtaining a plurality of training images, each including one or more labeled features, and training, using the plurality of training images, the machine learning network to predict the one or more labeled features in a raw application image. Training the machine learning network includes, for each image in the plurality of training images, predicting, using the machine learning network, one or more candidate labeled features from the image and forming a metric measuring a mismatch of the one or more candidate labeled features and the one or more labeled features. Training the machine learning network further includes, for each image in the plurality of training images, updating the machine learning network based, at least in part, on finding an extremum of the metric, and forming a trained machine learning network based, at least in part, on the update.

Embodiments disclosed herein generally relate to a method of determining maritime compliance. The method includes acquiring, using one or more image capture devices, a raw application image and processing the raw application image to produce a processed image. The method further includes inputting the processed image into a trained machine learning network and predicting one or more labeled features in the processed image using the trained machine learning network. The method further includes determining, with the trained machine learning network, a class of each of the one or more labeled features forming a set of determined classes. The method further includes determining, with the trained machine learning network, maritime compliance based, at least in part, on whether a first feature of the one or more labeled features is non-compliant based on the determined class of the first feature. The method further includes generating one or more alerts regarding maritime compliance based on a determination that the first feature is non-compliant.

Embodiments disclosed herein generally relate to a system for maritime compliance detection. The includes one or more image capture devices configured to acquire a raw application image and a maritime compliance detection system in communication with the image capture device. The maritime compliance detection system includes a processor and a memory storing instructions. The instructions, when executed by the processor, cause the processor to receive a raw application image, process the raw application image to produce a processed image, input the processed image into a trained machine learning network, and predict one or more labeled features in the processed image using the trained machine learning network. The instructions, when executed by the processor, further cause the processor to determine, with the trained machine learning network, a class of each of the one or more labeled features forming a set of determined classes. The instructions, when executed by the processor, further cause the processor to determine, with the trained machine learning network, maritime compliance based, at least in part, on whether a first feature of the one or more labeled features is non-compliant based on the determined class of the first feature. The instructions, when executed by the processor, further cause the processor to generate one or more alerts regarding maritime compliance based on a determination that the first feature is non-compliant.

Other aspects and advantages of the claimed subject matter will be apparent from the following description and the appended claims.

### BRIEF DESCRIPTION OF DRAWINGS

FIG. 1 depicts a terminal in accordance with one or more embodiments.

FIG. 2A depicts an image capture device in accordance with one or more embodiments.

FIG. 2B depicts a raw application image in accordance with one or more embodiments.

FIG. 3 depicts a system in accordance with one or more embodiments.

FIG. 4 depicts a neural network in accordance with one or more embodiments.

FIGS. 5A, 5B, and 5C depict examples in accordance with one or more embodiments.

FIGS. 6 and 7 depict flowcharts in accordance with one or more embodiments.

FIG. 8 depicts a computing system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. For example, a “raw application image” may include any number of “raw application images” without limitation.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

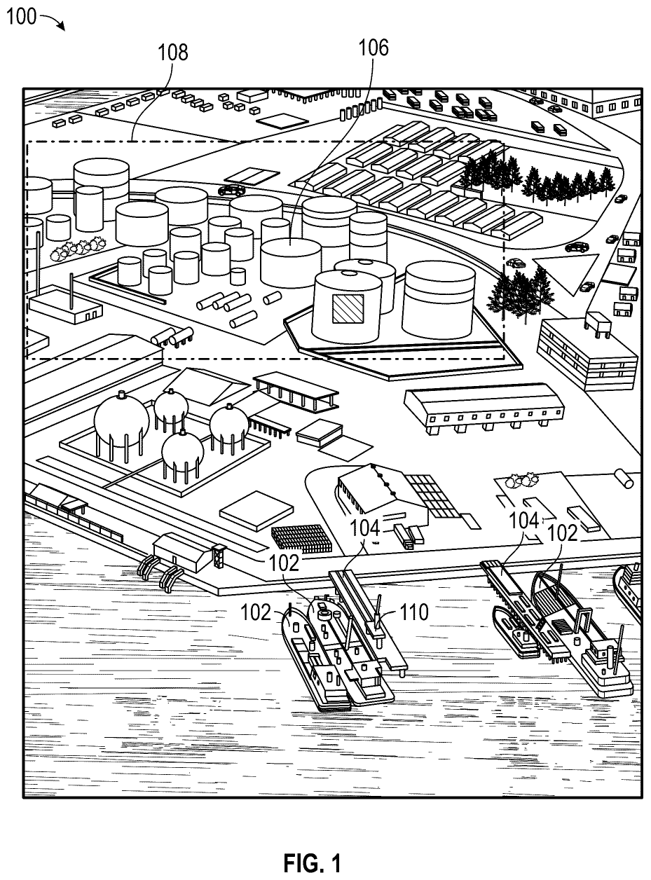

In the following description of FIGS. 1-8, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Vessels moving around a terminal are typically subject to national and international regulations enforced by terminal authorities and maritime agencies. For example, terminal authorities may have specific regulations governing the berthing of vessels at docks, or regulations regarding the handling and stowage of cargo within terminal areas. Maritime regulations are primarily aimed at ensuring the safety of vessels, crew, passengers, and the marine environment. By verifying compliance, authorities can identify and address potential safety hazards, reducing the risk of accidents, collisions, and environmental incidents. However, traditional compliance methods often rely on manual analysis and human judgment for verifying compliance, which may be time-consuming, labor-intensive, and does not provide real-time data. In addition, terminals may use traffic management systems, such as a Vessel Traffic Management System (VTMS), to monitor vessel movements and provide navigation assistance. However, VTMS systems only track the presence and movements of vessels and are not suitable for detecting maritime compliance. Methods and systems for automatic detection of violations of regulations, raising of alarms as a result of regulations violations, and post-violation investigations (e.g., auditing) are presented herein.

FIG. 1 shows an example of a terminal (100) in accordance with one or more embodiments. Specifically, FIG. 1 shows an oil terminal, which is a specialized facility designed for the storage, handling, and distribution of petroleum products. It is noted that many types of terminals exist. Therefore, one with ordinary skill in the art will recognize that any type of terminals may be employed without departing from the scope of this disclosure. Further, it is emphasized that the following discussions of an oil terminal are basic summaries and should not be considered limiting.

In FIG. 1, the oil terminal (100) may be located in or near coastal locations where vessels, such as the vessels (102) (e.g., oil tankers, including deep draft tankers), can discharge or load petroleum products. In one or more embodiments, the oil terminal (100) may be part of or contiguous with a refinery. The terminal (100) includes berthing and docking areas (104) where ships dock to load and unload cargo. Further, oil terminals (100) may have large storage tanks (106) to hold different types of petroleum and oil products (e.g., crude oil, gasoline, diesel, jet fuel, etc.). Storage tanks are typically arranged in clusters, also referred to as tank farms (108). In addition, oil terminals (100) are equipped with loading and unloading facilities (110) to transfer petroleum products between storage tanks, vessels (102), barges, and trucks, including, but not limited to, pipelines, pumps, hoses, and loading arms. For example, in some embodiments, oil terminals (100) may be connected to pipeline networks for transporting petroleum products to and from refineries, distribution centers, and other terminals. For oil terminals (100) located in or near coastal locations, marine facilities may receive and dispatch oil tankers. These facilities may include berths, jetties, mooring equipment, and ship-to-shore transfer systems.

Given the critical nature of oil terminals (100) and the monetary value of petroleum products, the terminal (100) has security measures in place to protect cargo, personnel, and infrastructure. These measures may include surveillance cameras, security patrols, access control systems, and perimeter fencing. In addition, the terminal (100) has a mandatory VTMS used to improve navigational safety for all vessels (102). For example, a VTMS may provide information on channel and terminal (100) conditions, congestion, weather, tides, navigational aids, etc. In addition, a VTMS may provide information on the movement of other vessels (102), dangerous maneuvering situations, vessels violating terminal (100) rules and regulations, berthing prospects, and anchoring conditions. In some embodiments, the VTMS provides advice on terminal (100) rules regarding the movement of vessels (102) and the priorities of vessel (102) movements. For example, it may be necessary for vessels (102) arriving to reduce speed to permit safe passage for an outgoing vessel (102).

While the VTMS is necessary for safe and effective monitoring and managing of maritime traffic of a terminal (100), often their use is inherently limited. For example, a major disadvantage of traditional VTMS systems is that they only detect the presence and movements of vessels (102) in a given location and do not ensure that maritime compliance (including Health, Safety, and Environment (HSE) compliance) protocols are followed. Unfortunately, maritime compliance incidents cause many injuries in terminal (100) facilities. These incidents involve floating unidentified objects, drifting buoys, and “Man overboard!” situations. A “Man overboard!” situation occurs when someone from the crew of a ship falls out at sea from the ship due to bad weather, accidents, or negligence.

In addition, VTMS cannot automatically determine a Closest Point of Approach (CPA) of an incoming vessel (102) to prevent damage to Single Point Mooring (SPM) buoys and terminal (100) facilities. A SPM is a floating buoy anchored offshore that serves as a mooring point for tankers and other vessels (102) to load or offload liquid cargo (e.g., petroleum products such as crude oil or refined products such as gasoline and diesel). The buoy is securely anchored to the seabed using anchor chains and provides the mooring point where the tankers and vessels (102) connects for cargo transfer operations. Crude oil and bunkers (i.e., fuel) are received at each SPM buoy from the oil terminal (100) through submarine pipelines, which are connected to the SPM buoy by flexible under-buoy hoses. The SPM buoy is connected to the tankers and vessels (102) using floating hoses, which are specially designed to withstand the harsh marine environment and high-volume cargo transfer. Conventionally, the SPM buoys are established nearby or around oil terminals (100). Taken together, VTMS have their own set of potential errors and limitations for applications involving maritime compliance detection.

The present disclosure may be an improvement over current methods used to determine maritime compliance. For instance, current methods rely on manual analysis and human judgment. Consequently, existing methods fail to capture associated compliance violations when operating conditions change. For example, traditional methods typically address violations after they occur (i.e., reactively) rather than predicting and preventing them before they occur (i.e., proactively). Further, these methods often heavily rely on human judgment for assessment, which may be subject to errors, bias, and inconsistencies. Manual compliance inspections, audits, and analysis are also time-consuming and require significant human resources, thus leading to delays and increased costs. Importantly, due to the complexity and large volume of images involved, proactively predicting when compliance violations occur is generally a difficult task. Therefore, proactively determining compliance violations is essential for risk mitigation and regulatory compliance.

Embodiments disclosed herein generally relate to methods and systems for determining maritime compliance in a terminal (100). As will be described, these methods and systems use a machine learning (ML) network to proactively identify unsafe behavior and actions in the terminal (100). This is accomplished by acquiring images of the terminal (100) using an image capture device and analyzing them using a ML network for object detection and identification. The ML network is described in greater detail later in this disclosure. However, for now it is sufficient to state that the maritime compliance detection system detects and classifies features (e.g., objects, such as maritime compliance elements, and/or people) present in an image and/or a part of an image (e.g., a Region of Interest (ROI)). Detection indicates the location of a feature in a processed image. In addition, detected features are classified by the ML network. For each detected feature a class probability distribution, indicating the probability that a feature belongs to each class in a given set of classes, is returned. Further, the ML network determines a compliance state for each feature. For example, the compliance state can be binary such as “compliant” or “non-compliant,” or multinomial such as “compliant,” “non-compliant,” or “compliance undetermined.” In one or more embodiments the ML network may further specify the type of non-compliance by comparing each feature against a ruleset. As such, this proactive approach improves upon traditional methods by utilizing data more effectively, eliminating the bias of human judgment, and offering predictive capabilities. In addition, it allows organizations to implement compliance measures and mitigate risk ahead of time, thus fostering a safer work environment and a more efficient resource allocation.

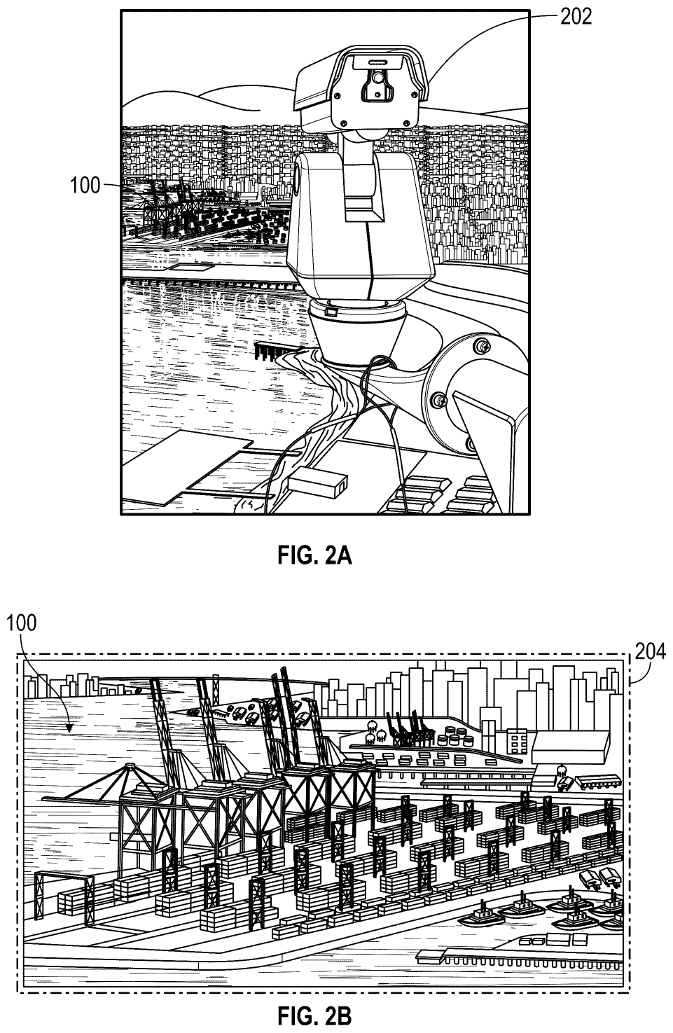

FIG. 2A shows an image capture device (202) monitoring the movement of vessels, such as vessels (102), in the terminal (100) in accordance with one or more embodiments. The image capture device (202) is positioned to acquire images and/or a video stream of the vessels. While the image capture device (202) is shown mounted to a fixed location in the terminal (100) in FIG. 2A, in some embodiments, the image capture device (202) may be located remotely from the terminal (100). For example, the image capture device (202) may be mounted on a moving vessel. In other embodiments, the images and/or a video stream may be captured using a drone or a satellite.

A raw application image (204), as shown by the dashed box in FIG. 2B, is acquired by the image capture device (202) as a visual spatial representation of the terminal (100) within the field of view of the image capture device (202) at an instance in time. The image capture device (202) is of high resolution, and of adequate frame rate, such that raw application images (204) are obtained by the image capture device (202) in real-time or near real-time. Suitable image capture devices (202) include, but are not limited to, digital still cameras, time-lapse cameras, digital video cameras, analog video cameras, color and/or monochrome cameras, closed-circuit television (CCTV) cameras, pan-tilt-zoom (PTZ) cameras, infrared cameras, night vision cameras, etc. Any suitable camera that is capable of high resolution images and/or video in real-time, now known or later developed, may be employed for embodiments disclosed herein.

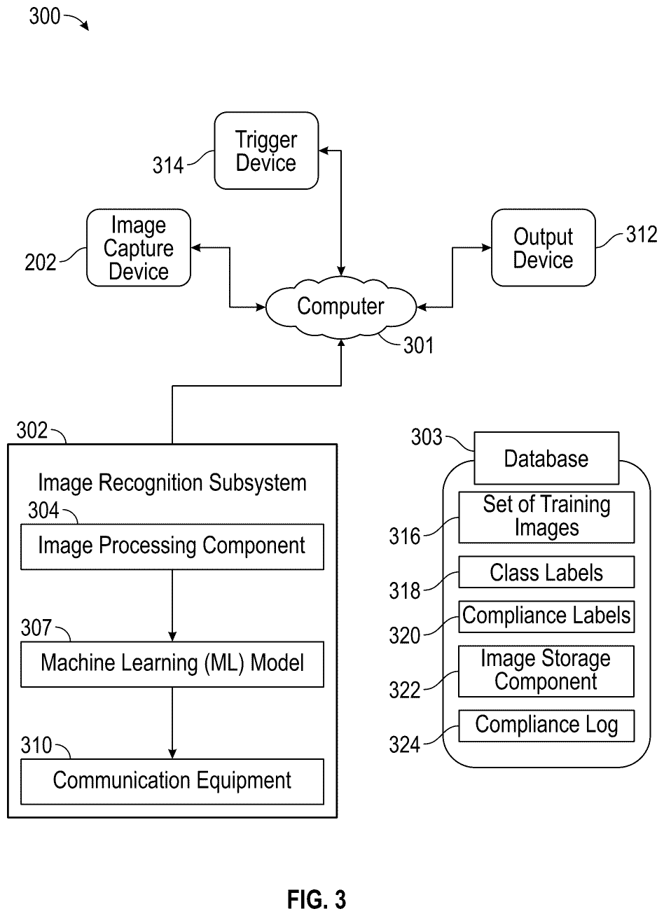

FIG. 3 depicts the maritime compliance detection system (300) in accordance with one or more embodiments. FIG. 3 depicts, as a block diagram, various components, modules, and/or subsystems, where the components, modules, and/or subsystems are communicatively coupled and may interact with each other. For example, in FIG. 3, a ML-based image recognition subsystem (302) is shown to interact with the image capture device (202) and a database (303). FIG. 3 is intended to promote a clear discussion and should not be considered fixed or limiting. A person of ordinary skill in the art will recognize that many permutations of the partitioning, organization, and interaction of the components, modules, and/or subsystems of the maritime compliance detection system (300), alongside interactions within said components, modules, and/or subsystems, may be employed without departing from the scope of this disclosure. For example, FIG. 3 depicts the database (303) as an independent entity, however, in some embodiments, the database (303) may be encompassed by the image recognition subsystem (302).

In accordance with one or more embodiments, the maritime compliance detection system (300) has access to, at least, a database (303). The database (303) stores digital media, such as data descriptive of one or more features (e.g., objects, such as maritime compliance elements, and/or people) that may be present in the terminal (100). In one or more embodiments, the database (303) stores a set of training images (316) where each image is a pictorial depiction of a feature in the terminal (100). The set of training images (316) may be acquired and curated from a variety of sources, including images provided by the terminal (100) or obtained from a website.

In accordance with one or more embodiments, the database (303) includes class labels (318). Each training image in the set of training images (316) may be associated with a class label, the class label stored in class labels (318) of the database (303), and the class label identifying a feature in the training image. For example, a training image may be an image of a lifeboat in which case the class label associated with the training image is “lifeboat.” In instances where multiple types of features exist, for example, lifeboats of different sizes or construction, labels with greater specificity can be used.

In accordance with one or more embodiments, the database (303) includes compliance labels (320). A given feature may have more than one associate training image in the set of training images (316). For example, given a feature, the set of training images (316) can contain images of the given feature in a compliant and a non-compliant state. As such, these training images in the set of training images (316) may each be associated with a compliance label (320). The compliance label (320) indicates, at least, whether the feature in the associated training image is non-compliant. In some embodiments, the compliance label (320) may further indicate a type of non-compliance and the location (e.g., spatial location) where the non-compliance is observed. For a given feature, many training images with corresponding compliance label (320) may exist and be stored in the database (303).

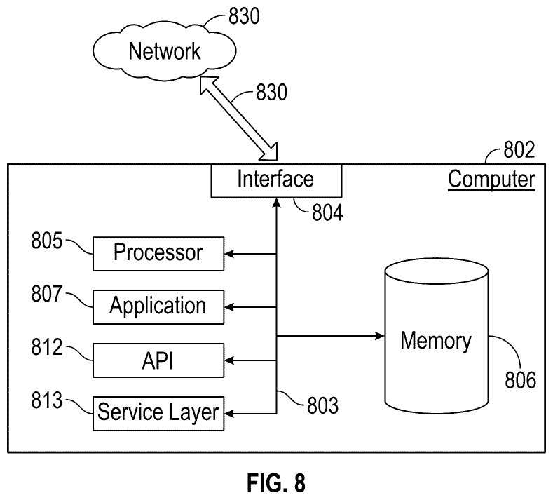

In some embodiments, the maritime compliance detection system (300) may include hardware and/or software with functionality for determining maritime compliance. For this purpose, the system may include memory with one or more data structures, such as a buffer, a table, an array, or any other suitable storage medium. In some embodiments, the maritime compliance detection system (300) may include a computer system (301) similar to the computer system (802) described below with regard to FIG. 8 and the accompanying description. In one or more embodiments, the components, modules, and/or subsystems of the maritime compliance detection system (300) communicates wirelessly with the computer system (301). Wireless communication may be facilitated through Radio Frequency Identification (RFID), Near Field Communication (NFC), low-energy Bluetooth, low-energy wireless, low-energy radio protocols, LTE-A, and WiFi-Direct technologies, or other wireless methods, without departing from the scope of this disclosure.

As depicted in FIG. 3, the maritime compliance detection system (300) includes at least one image capture device (202). The circuitry, components, and connections for conveying the raw application images (204) to one or more additional components of the maritime compliance detection system (300), such as the ML-based image recognition subsystem (302), make up the image capture device (202).

In accordance with one or more embodiments, the maritime compliance detection system (300) includes a ML-based image recognition subsystem (302). The ML-based image recognition subsystem (302) includes an image processing component (304), a ML network (307), and a communication equipment (310), as described in greater detail below.

In accordance with one or more embodiments, the ML-based image recognition subsystem (302) may be used to analyze and verify maritime compliance in a terminal (100) based on the raw application images (204) obtained from the image capture device (202). Examples of use cases include, but are not limited to, detecting “Man overboard!” situations, detecting CPA based on the approaching speed of a vessel (102), detecting corrosion and cracks on vessels (102), detecting floating unidentified objects, detecting drifting buoys, detecting unused SPM buoys, and detecting unidentified flying objects and drones. Other examples include using the ML-based image recognition subsystem (302) to validate the Automatic Identification System (AIS) information received from arriving vessels (102) and identify any discrepancies. Further, in some embodiments, the ML-based image recognition subsystem (302) may be used to detect vessel shape, size, dimensions, height, and sink level.

In accordance with one or more embodiments, the database (303) may include an image storage component (322) used to store image data during the image recognition process. The image storage component (322) may include a circular storage buffer configured to keep a buffer of raw application images (204) obtained from the image capture device (202). The raw application images (204) may be saved in sequence in the image storage component (322) until the end of the available memory is reached, and then storing may begin again at the beginning of the image storage component (322), thus overwriting the oldest stored image data. The scope of the memory architectures disclosed herein should not be considered limiting and different memory architectures may be used. Further, in accordance with one or more embodiments, a trigger signal generated from a trigger device (314) may result in storing the raw application images (204) in the image storage component (322). In such an embodiment, the raw application images (204) stored in the image storage component (322) may be retrieved and used as background reference images by the ML-based image recognition subsystem (302).

In accordance with one or more embodiments, the raw application images (204) acquired by the image capture device (202) undergo processing by the image processing component (304). In some embodiments, processing of the raw application images (204) may include background subtraction, and in such embodiment a background removal subcomponent (not shown) may be included as part of the image processing component (304). Further, in such embodiment, the image processing component (304) compares the raw application images (204) to a reference or background image and uses image subtraction to obtain a background-subtracted image and identifies pixels that may have changed between the two images. As such, a ROI can be formed, and the procedures described in this disclosure to determine maritime compliance may be applied to the ROI. In one or more embodiments, the image processing component (304) may rely on a reference or background image (stored, e.g., in the image storage component (322) of the database (303) as previously described) for comparison with the one or more raw application images (204) and may perform image subtraction to identify those pixels that have changed.

In other embodiments, processing of the raw application images (204) using the image processing component (304) may include normalizing the images. Additional techniques such as denoising, filtering, and aggregating multiple images, or other methods designed to reduce noise in the raw application images (204) and increase the quality of the raw application images (204) may be employed. One with ordinary skill in the art will appreciate that many image processing techniques exist and the fact that they are not enumerated herein does not impose a limit on the present disclosure. Further, in some embodiments, processing of the raw application images (204) may not be required. The output of the image processing component (304) is a processed image.

In accordance with one or more embodiments, the processed image and/or a part of the processed image (e.g., a ROI) is further processed with a ML network (307) to detect, identify, label, count, and classify the features (e.g., objects, such as maritime compliance elements, and/or people) present in the processed image and/or a part of the processed image. Further, the ML network (307) determines a compliance state for each feature. The compliance state can be binary such as “compliant” or “non-compliant,” or multinomial such as “compliant,” “non-compliant,” or “compliance undetermined.” As such, an output of the ML network (307) is a determination of the set of classes (where a class identifies and/or describes a feature), quantity of each class, and a count of how many features in the processed image are compliant and non-compliant, without the need for a terminal operator to manually inspect for any maritime compliance violations.

In one or more embodiments, the ML network (307) may further output an annotated version of the one or more processed images that labels all visible features and indicates the location of non-compliant features, if any. For example, the ML network (307) may determine if the location of any vessels (102), buoys, pilots, crew personnel, and drones in the terminal (100) is in violation of maritime compliance regulations. Further, in one or more embodiments, the ML network (307) may further specify the type of non-compliance. In accordance with one or more embodiments, upon a determination of a non-compliant state, a trigger signal may be generated from a trigger device (314) to store the processed images in the image storage component (322).

In accordance with one or more embodiments, the ML network (307) may determine if the features (e.g., objects, such as maritime compliance elements, and/or people) previously labeled and classified using the ML network (307) are compliant with maritime and safety (e.g., HSE) regulations by comparing, for example, each feature against a ruleset such as the use cases previously described (and other ones not described).

In accordance with one or more embodiments, the ML network (307) performs pose estimation and face detection of people present in the processed image. Information obtained from a pose estimation algorithm allows the maritime compliance detection system (300) to determine the body posture of people in the terminal (100). In some embodiments, pose estimation may be used to detect “Man overboard!” situations. Further, in accordance with one or more embodiments, the ML network (307) may determine if a person in the terminal (100) is not properly wearing safety equipment (e.g., Personal Protective Equipment (PPE)).

In one or more embodiments, the ML network (307) is executed on the computer system (301), where the computer system (301) may be like that depicted and described with reference to FIG. 8 below. In embodiments where the computer system (301) is used, the ML-based image recognition subsystem (302) may transmit one or more raw application images (204), acquired using the image capture device (202), to the computer system (301) for processing. The computer system (301), in turn, may transmit a processed image to the ML-based image recognition subsystem (302) upon processing of the one or more raw application images (204). Further, the computer system (301) can interact with a database (303) to store images in the image storage component (322) together with their associated class (318) and compliance labels (320) as determined using the ML network (307).

The ML network (307) may be composed of multiple ML networks, acting in coordination or independently. In the case of multiple ML networks, these networks may be ensembled together or each network may be responsible for producing a specific output. Additionally, the ML network (307) may be supervised or unsupervised.

As stated, the image recognition subsystem (302) includes a ML network (307). Machine learning, broadly defined, is the extraction of patterns and insights from data. The phrases “artificial intelligence”, “machine learning”, “deep learning”, and “pattern recognition” are often convoluted, interchanged, and used synonymously throughout the literature. This ambiguity arises because the field of “extracting patterns and insights from data” was developed simultaneously and disjointedly among a number of classical arts like mathematics, statistics, and computer science. For consistency, the term machine learning (ML) will be adopted herein, however, one skilled in the art will recognize that the concepts and methods detailed hereafter are not limited by this choice of nomenclature.

ML network types may include, but are not limited to, generalized linear networks, Bayesian regression, random forests, and deep networks such as neural networks, convolutional neural networks, and vision transformers. ML network types, whether they are considered deep or not, are usually associated with additional “hyperparameters” which further describe the network. For example, hyperparameters providing further detail about a neural network may include, but are not limited to, the number of layers in the neural network, choice of activation functions, inclusion of batch normalization layers, and regularization strength.

Commonly, in the literature, the selection of hyperparameters surrounding a ML network is referred to as selecting the network “architecture.” Once a ML network type and hyperparameters have been selected, the ML network is trained to perform a task. In one or more embodiments, the ML network (307) is trained using the set of training images (316) and their associated labeled features (i.e., class (318) and compliance labels (320)).

In accordance with one or more embodiments, once a ML network type and associated architecture are selected, the ML network (307) is trained to predict candidate labeled features. For example, in one or more embodiments, the ML network (307) is trained to detect and classify (i.e., assign a class) to the features (e.g., objects, such as maritime compliance elements, and/or people) present in the processed image acquired using the image capture device (202). In addition, in one or more embodiments, the ML network (307) is trained to, at least, classify a processed image as compliant or non-compliant, and further specify the type of non-compliance and/or indicate the location of any non-compliant features in the processed image.

After the prediction of each candidate labeled feature, a metric measuring the mismatch between the labeled features of the training images (316) and the candidate labeled features predicted by the ML network may be formed. The metric may be a predefined accuracy metric that gives an allowable mismatch criterion for a successful prediction. The ML network may be updated based, at least in part, on finding an extremum of the metric. Once trained, the performance of the ML network (307) may be evaluated (e.g., using a partition of training data not seen during training known as a “hold-out set” or “validation set”) and this ML network is used in a production setting (also known as deployment of the ML network), where the production setting indicates the use of the ML network by the maritime compliance detection system (300).

As noted, the objective of the ML network (307) is to detect and classify instances of features. Detection indicates the location of a feature in a processed image. The location of a feature may be indicated using a bounding box that circumscribes the portion of the processed image containing the feature or the location of a feature may be indicated pixelwise, where each pixel which is found to be associated with a feature is flagged or given an identifier (i.e., instance segmentation). Detected features are also classified by the ML network (307). For each detected feature, a class probability distribution is returned. The class probability distribution indicates the probability that a feature belongs to each class in a given set of classes (e.g., class labels (318)). For example, each feature (e.g., objects, such as maritime compliance elements, and/or people) may be classified according to a set of classes including the classes {‘vessel’, ‘buoy’, ‘SPM buoy’, ‘life jacket’, ‘lifebuoy’, ‘lifeboat’, ‘life raft’, ‘immersion suit’, ‘PPE’, ‘people’, etc.}. Thus, the ML network (307) returns, at least, the location and class distribution of detected features in the processed image.

In accordance with one or more embodiments, the ML network (307) used in the maritime compliance detection system (300) disclosed herein is a convolutional neural network (CNN). In particular, in one or more embodiments, the architecture of the CNN is based, or is, the You Only Look Once (YOLO) object detection network. YOLO follows a grid-based approach and divides the input image into a grid of cells. Each cell is responsible for predicting bounding boxes and their corresponding class probabilities. Therefore, YOLO can detect multiple objects in a single image in a fast and efficient manner. It is noted that various versions of YOLO exist and differ in such things as the types of layers used, resolution of training data, etc. However, a defining trait of all YOLO versions is that multiple objects of varied scales can be detected in a single pass. In accordance with one or more embodiments, YOLO can be used to identify the edges of features (e.g., objects, such as maritime compliance elements, and/or people) in a processed image. As such, a ROI can be formed by a group of intersecting edges, and the procedures described in this disclosure to determine maritime compliance may be applied to the ROI. Further, in other embodiments, the architecture of the CNN may be similar to the architecture of the residual neural network ResNet50.

Many ML network (307) architectures are described in the literature for the task of object detection and identification. These ML networks are usually based on one or more CNNs. For example, regional based CNNs (R-CNNs) and single shot detectors (SSDs) (and their variants) are commonly employed architectures. Other suitable computer vision algorithms for object detection and identification include, but are not limited to, Canny imaging, Harris corner imaging, Shen-Castan edge detection, grey level segmentation, and skeletonization. For classification, various classification algorithms can be used to determine if one or more features are present in the processed image and/or a part of the processed image (e.g., a ROI). For example, depending on multiple classifiers, a vector space classifier model and/or an adaptive learning algorithm (e.g., AdaBoost) may be used. Further, the classification algorithms might be based on picture attributes, detected features, and/or extracted portions such as one or more edges, lines, Haar-like features, ResNet generated features, local binary pattern, Histogram Orientation Gradient (HOG), Gabor filtered features, etc. Any of these architectures, or others not explicitly referenced herein, may be used by the ML network (307) of the maritime compliance detection system (300) without departing from the scope of the instant disclosure.

A CNN, such YOLO or ResNet, may be more readily understood as a specialized neural network (NN). Thus, a cursory introduction to a NN and a CNN are provided herein. However, it is noted that many variations of a NN and CNN exist. Therefore, one with ordinary skill in the art will recognize that any variation of the NN or CNN (or any other ML network) may be employed without departing from the scope of this disclosure. Further, it is emphasized that the following discussions of a NN and a CNN are basic summaries and should not be considered limiting.

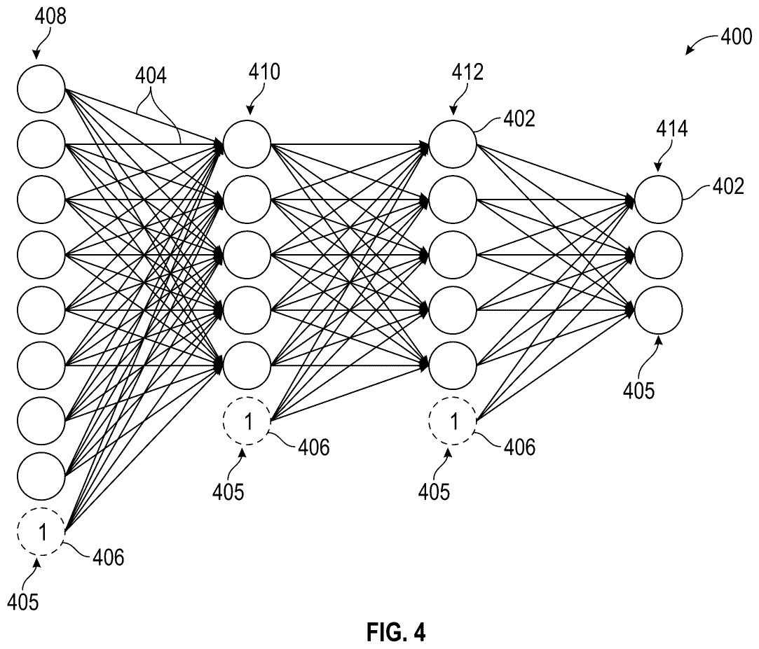

A diagram of a neural network is shown in FIG. 4. At a high level, a neural network (400) may be graphically depicted as being composed of nodes (402), where here any circle represents a node, and edges (404), shown here as directed lines. The nodes (402) may be grouped to form layers (405). FIG. 4 displays four layers (408, 410, 412, 414) of nodes (402) where the nodes (402) are grouped into columns, however, the grouping need not be as shown in FIG. 4. The edges (404) connect the nodes (402). Edges (404) may connect, or not connect, to any node(s) (402) regardless of which layer (405) the node(s) (402) is in. That is, the nodes (402) may be sparsely and residually connected. A neural network (400) will have at least two layers (405), where the first layer (408) is considered the “input layer” and the last layer (414) is the “output layer”. Any intermediate layer (410, 412) is usually described as a “hidden layer”. A neural network (400) may have zero or more hidden layers (410, 412) and a neural network (400) with at least one hidden layer (410, 412) may be described as a “deep” neural network or as a “deep learning method”. In general, a neural network (400) may have more than one node (402) in the output layer (414). In this case the neural network (400) may be referred to as a “multi-target” or “multi-output” network.

Nodes (402) and edges (404) carry additional associations. Namely, every edge is associated with a numerical value. The edge numerical values, or even the edges (404) themselves, are often referred to as “weights” or “parameters”. While training a neural network (400), numerical values are assigned to each edge (404). Additionally, every node (402) is associated with a numerical variable and an activation function. Activation functions are not limited to any functional class, but traditionally follow the form

$$A = f ( {\sum }_{i ∈ ( incoming )} [ {( node value )}_{i} {( edge value )}_{i} ] ) , \qquad EQ 1$$

where i is an index that spans the set of “incoming” nodes (402) and edges (404) and f is a user-defined function. Incoming nodes (402) are those that, when viewed as a graph (as in FIG. 4), have directed arrows that point to the node (402) where the numerical value is being computed. Some functions for f may include the linear function f(x)=x, sigmoid function

$$f ( x ) = \frac{1}{1 + {e}^{- x}} ,$$

and rectified linear unit function f(x)=max(0, x), however, many additional functions are commonly employed. Every node (402) in a neural network (400) may have a different associated activation function. Often, as a shorthand, activation functions are described by the function f by which it is composed. That is, an activation function composed of a linear function f may simply be referred to as a linear activation function without undue ambiguity.

When the neural network (400) receives an input, the input is propagated through the network according to the activation functions and incoming node (402) values and edge (404) values to compute a value for each node (402). That is, the numerical value for each node (402) may change for each received input. Occasionally, nodes (402) are assigned fixed numerical values, such as the value of 1, that are not affected by the input or altered according to edge (404) values and activation functions. Fixed nodes (402) are often referred to as “biases” or “bias nodes” (406), displayed in FIG. 4 with a dashed circle.

In some implementations, the neural network (400) may contain specialized layers (405), such as a normalization layer, or additional connection procedures, like concatenation. One skilled in the art will appreciate that these alterations do not exceed the scope of this disclosure.

As noted, the training procedure for the neural network (400) comprises assigning values to the edges (404). To begin training the edges (404) are assigned initial values. These values may be assigned randomly, assigned according to a prescribed distribution, assigned manually, or by some other assignment mechanism. Once edge (404) values have been initialized, the neural network (400) may act as a function, such that it may receive inputs and produce an output. As such, at least one input is propagated through the neural network (400) to produce an output. Training data is provided to the neural network (400). Generally, training data consists of pairs of inputs and associated targets. The targets represent the “ground truth”, or the otherwise desired output, upon processing the inputs. In the context of the instant disclosure, an input is a processed image depicting features (e.g., objects, such as maritime compliance elements, and/or people) and its associated target is a data structure indicating the location (e.g., bounding box) and class (i.e., class label (318)) of each feature depicted in the processed image.

During training, the neural network (400) processes at least one input from the training data and produces at least one output. Each neural network (400) output is compared to its associated input data target. The comparison of the neural network (400) output to the target is typically performed by a so-called “loss function”; although other names for this comparison function such as “metric”, “error function,” “misfit function,” and “cost function” are commonly employed. Many types of loss functions are available, such as the mean-squared-error function, however, the general characteristic of a loss function is that the loss function provides a numerical evaluation of the similarity between the neural network (400) output and the associated target. The loss function may also be constructed to impose additional constraints on the values assumed by the edges (404), for example, by adding a penalty term, which may be physics-based, or a regularization term. Generally, the goal of a training procedure is to alter the edge (404) values to promote similarity between the neural network (400) output and associated target over the training data. Thus, the loss function is used to guide changes made to the edge (404) values, typically through a process called “backpropagation.”

While a full review of the backpropagation process exceeds the scope of this disclosure, a brief summary is provided. Backpropagation consists of computing the gradient of the loss function over the edge (404) values. The gradient indicates the direction of change in the edge (404) values that results in the greatest change to the loss function. Because the gradient is local to the current edge (404) values, the edge (404) values are typically updated by a “step” in the direction indicated by the gradient. The step size is often referred to as the “learning rate” and need not remain fixed during the training process. Additionally, the step size and direction may be informed by previously seen edge (404) values or previously computed gradients. Such methods for determining the step direction are usually referred to as “momentum” based methods.

Once the edge (404) values have been updated, or altered from their initial values, through a backpropagation step, the neural network (400) will likely produce different outputs. Thus, the procedure of propagating at least one input through the neural network (400), comparing the neural network (400) output with the associated target with a loss function, computing the gradient of the loss function with respect to the edge (404) values, and updating the edge (404) values with a step guided by the gradient, is repeated until a termination criterion is reached. Common termination criteria are: reaching a fixed number of edge (404) updates, otherwise known as an iteration counter; a diminishing learning rate; noting no appreciable change in the loss function between iterations; reaching a specified performance metric as evaluated on the data or a separate hold-out data set. Once the termination criterion is satisfied, and the edge (404) values are no longer intended to be altered, the neural network (400) is said to be “trained.”

A CNN is similar to a neural network (400) in that it can technically be graphically represented by a series of edges (404) and nodes (402) grouped to form layers. However, it is more informative to view a CNN as structural groupings of weights; where here the term structural indicates that the weights within a group have a relationship. CNNs are widely applied when the data inputs also have a structural relationship, for example, a spatial relationship where one input is always considered “to the left” of another input. Images have such a structural relationship. Consequently, a CNN is an intuitive choice for the task of object detection, identification, and detecting maritime compliance in a processed image.

A structural grouping, or group, of weights is herein referred to as a “filter”. The number of weights in a filter is typically much less than the number of inputs, where here the number of inputs refers to the number of pixels in an image. In a CNN, the filters can be thought as “sliding” over, or convolving with, the inputs to form an intermediate output or intermediate representation of the inputs which still possesses a structural relationship. Similar to the neural network (400), the intermediate outputs are often further processed with an activation function. Many filters may be applied to the inputs to form many intermediate representations. Additional filters may be formed to operate on the intermediate representations creating more intermediate representations. This process may be repeated as prescribed by a user. There is a “final” group of intermediate representations, wherein no more filters act on these intermediate representations. In some instances, the structural relationship of the final intermediate representations is ablated; a process known as “flattening”. The flattened representation may be passed to a neural network (400) to produce a final output. Note, that in this context, the neural network (400) is still considered part of the CNN. Similar to a neural network (400), a CNN is trained, after initialization of the filter weights, and the edge (404) values of the internal neural network (400), if present, with the backpropagation process in accordance with a loss function.

As will be appreciated by one skilled in the art, the neural network (400) according to embodiments of the present disclosure can be implemented on a general purpose computer similar to the computer system (802) described below with regard to FIG. 8 and the accompanying description. However, the neural network (400) may also be implemented on a special purpose computer, a programmed microprocessor or microcontroller, an integrated circuit, a hardware electronic or logic circuit such as a discrete element circuit, a programmable logic device, or any other programmable data processing apparatus.

Returning to FIG. 3, in accordance with one or more embodiments, the ML network (307) can issue a command or control signal to an external system or process using the communication equipment (310). For example, the control signal may generate an alarm or notification to a user that one or more detected features (e.g., objects, such as maritime compliance elements, and/or people) have been determined to be non-compliant by the maritime compliance detection system (300). In such an embodiment, the communication equipment (310) may transmit the control signal to an output device (312) (e.g., a web-based dashboard) that presents alerts (e.g., a visual warning) to terminal operators in real-time.

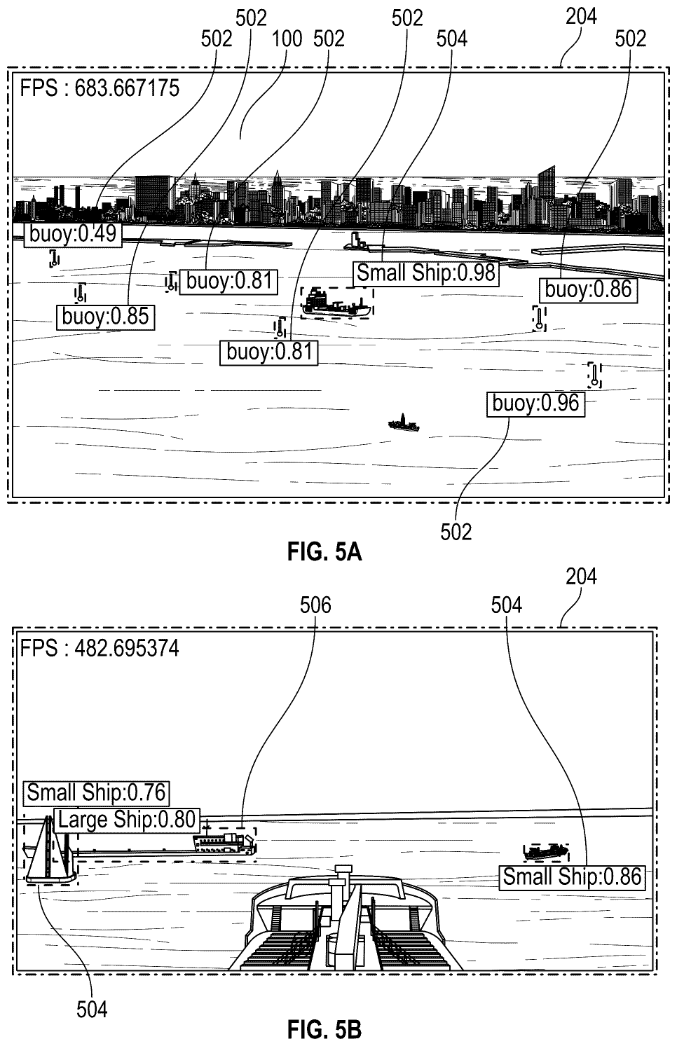

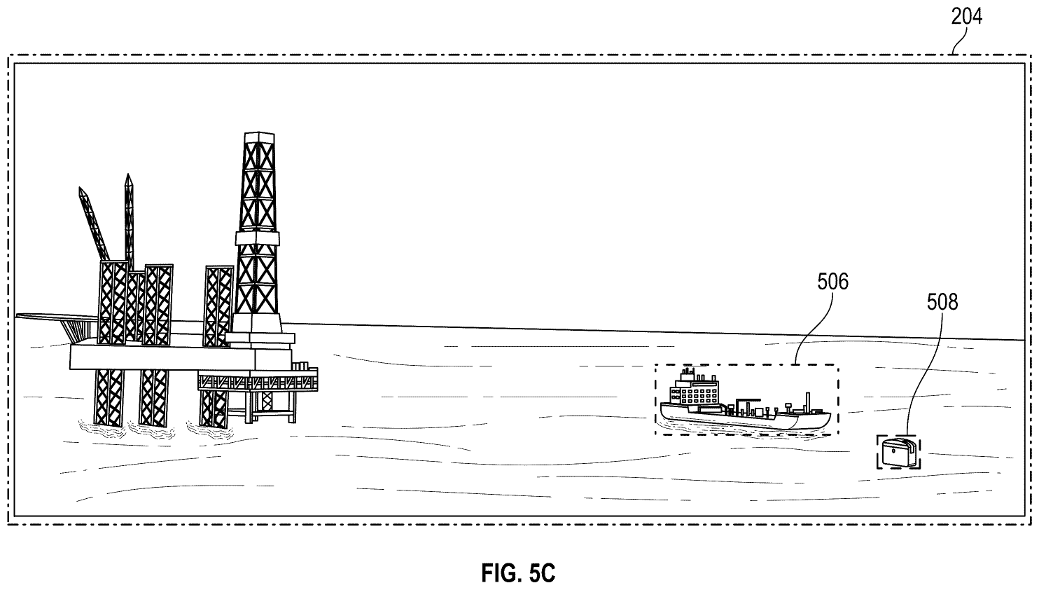

By way of an example, FIG. 5 depicts an implementation of the maritime compliance detection system (300) in accordance with one or more embodiments. As previously stated, the ML network (307) detects and classifies instances of features (e.g., objects, such as maritime compliance elements, and/or people) present in a raw application image (204) acquired, for example, using the image capture device (202) and processed with the image processing component (304). The image capture device (202) is of high resolution, and of adequate frame rate (e.g., 684 FPS in FIG. 5A and 483 FPS in FIG. 5B), such that the raw application images (204) are obtained by the image capture device (202) in real-time or near real-time. Higher FPS image capture devices (202) capture more frames per second, providing finer temporal resolution for tracking object motion.

In accordance with one or more embodiments, FIG. 5 shows that the ML network (307) outputs a bounding box indicating the location of features present in the processed image. In addition, as noted, detected features are also classified by the ML network (307) and a class probability distribution, indicating the probability that a feature belongs to each class in a given set of classes, is returned. Thus, the ML network (307) returns, at least, the location and class distribution of each detected feature in the processed image.

In accordance with one or more embodiments, FIGS. 5A-FIG. 5C show bounding boxes that circumscribe the portion of the processed image containing a feature, a classification of each feature (e.g., buoys (502), ships (504, 506), SPM buoys (508), etc.), and a probability between 0 and 1 that a feature belongs to that class. Further, as previously stated, in instances where multiple types of features exist, for example, vessels (102) of different sizes or construction, labels with greater specificity can be used. For example, FIG. 5B depicts a “small ship” (5J04) and a “large ship” (506). In accordance with one or more embodiments, FIG. 5A is an implementation of the maritime compliance detection system (300) in a terminal (100). FIGS. 5B-FIG. 5C are implementations of the maritime compliance detection system (300) in which the image capture device (202) is located remotely from the terminal (100). For example, in FIG. 5B the image capture device (202) is mounted on a moving vessel (102).

In accordance with one or more embodiments, FIG. 5C depicts an offshore implementation of the maritime compliance detection system (300) that detects the CPA of an incoming vessel (102). Initially, the CPA may be determined by calculating the time interval between two (or more) frames of a processed image, which can be obtained using the FPS of the image capture device (202). The distance between two or more features (e.g., the incoming moving vessel (102) and a static SPM buoy) may be determined by measuring the relative displacement (in pixels) between the two (or more) frames. The pixel-based measurements may be converted to standard units using a scale bar on the processed image or known distances in the field of view of the image capture device (202). As such, the average speed of the incoming vessel (102) may be determined by dividing the displacement by the time interval. In such an embodiment, the CPA may be used to prevent damage to SPM buoys.

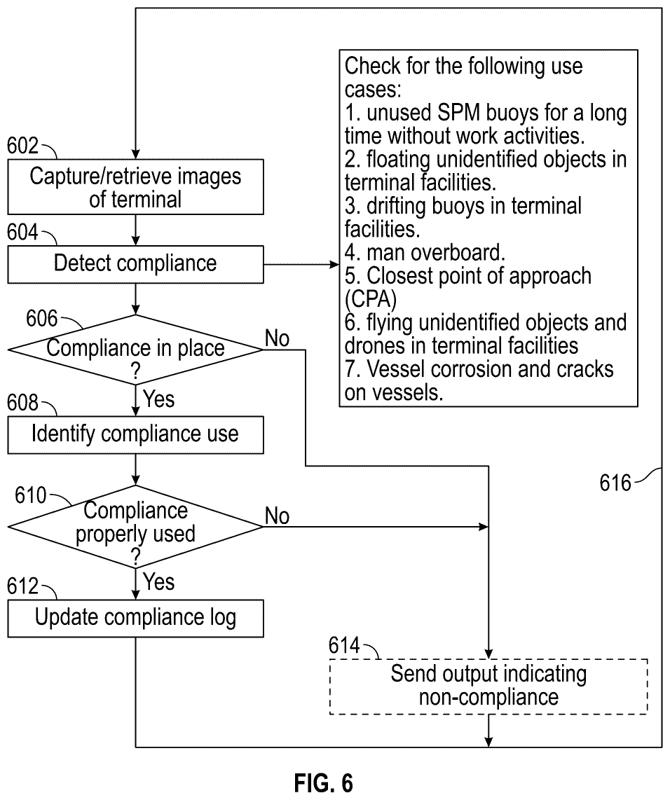

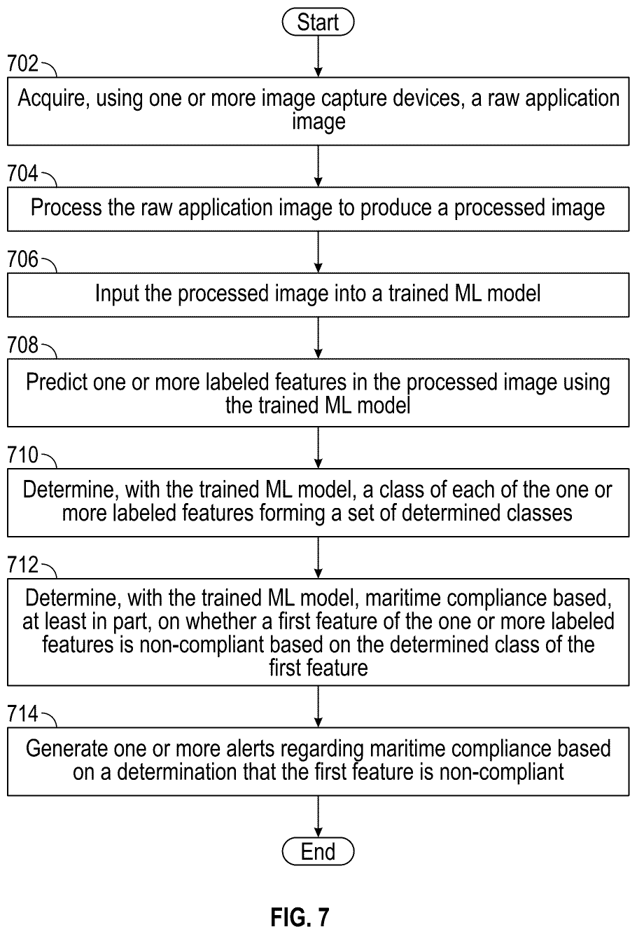

FIGS. 6 and 7 show flowcharts in accordance with one or more embodiments of the invention.

FIG. 6 depicts, at a high-level, a flowchart outlining the use of the maritime compliance detection system (300). As depicted, in Block 602, a raw application image (204) is acquired by the image capture device (202) or retrieved from an image storage component (322). The image capture device (202) is positioned to acquire images and/or a video stream. In accordance with one or more embodiments, the raw application images (204) acquired by the image capture device (202) undergo processing by the image processing component (304). In some embodiments, processing of the raw application images (204) may include background subtraction. In such embodiment, the image processing component (304) compares the raw application images (204) to a reference or background image and uses image subtraction to obtain a background-subtracted image and identifies pixels that may have changed between the two images. As such, a ROI can be formed, and the procedures described in this disclosure to determine maritime compliance may be applied to the ROI.

In Block 604, the processed image and/or a part of the processed image (e.g., a ROI) is processed with a ML network (307) to identify, label, and classify any features (e.g., objects, such as maritime compliance elements, and/or people) present in the processed image. Further, the ML network (307) performs pose estimation and face detection of the people present in the processed image.

Keeping with Block 604, in accordance with one or more embodiments, the ML network (307) may determine if the features (e.g., objects, such as maritime compliance elements, and/or people) previously labeled and classified using the ML network (307) are compliant with maritime and safety (e.g., HSE) regulations by comparing each feature against a ruleset such as, for example, the one shown in FIG. 6, or others not shown. In other embodiments, the ML network (307) may determine if the location of any vessels (102), buoys, pilots, crew personnel, and drones in the terminal (100) is in violation of maritime compliance regulations.

In Block 606, a determination regarding compliance with maritime standards and regulations is made. If maritime compliance is detected, as determined by the ML network (307), then the maritime compliance detection system (300) may continue to Block 608. If maritime compliance is not detected, the maritime compliance detection system (300) may proceed to Block 614. For example, the maritime compliance detection system (300) can determine the presence or absence of vessels at the SPM to measure the utilization and consequently alert the VTMS operators for unused SPM buoys with no work activity. The maritime compliance detection system (300) may also determine floating and flying unidentified objects as well as drifting buoys near the terminal (100). Further, the maritime compliance detection system (300) may also recognize “Man overboard!” situations during vessel fueling at the SPM areas. The maritime compliance detection system (300) can also determine CPA and send alerts if it exceeds certain metrics thus avoiding collisions. Moreover, the maritime compliance detection system (300) can determine the health condition of the vessels at the terminal (100) based on the structure of the vessel, such as the height of the vessel, cracks, corrosion, and various structural features.

In Block 608, the maritime compliance detection system (300) further determines compliance with maritime standards by assessing if a person in the terminal (100) is not properly wearing safety equipment (e.g., PPE).

In Block 610, the maritime compliance detection system (300) may determine, from the images processed by the image processing component (304), whether the safety measures are met and in place. The maritime compliance detection system (300) may rely on extrinsic information, such as safety standards and information about the vessels inferred from the image analysis. If vessels, SPMs, and/or the surrounding environment are not compliant, the maritime compliance detection system (300) may output a non-compliant notification, such as an audible message for the VTMS operator or a text message for the foreman, supervisor, or HSE officer.

In Block 612, the maritime compliance detection system (300) records non-compliance events in the compliance log (324).

In Block 614, an output signal (e.g., an alert) indicative of a non-compliance event is generated. The output signal may include, for example, an indication that a person is not complying with maritime standards and regulations, information on an incident, etc. In some embodiments, the output signal may be transmitted to an output device (312) (e.g., a web-based dashboard) that presents alerts (e.g., a visual warning) to terminal operators in real-time. The terminal operator may then be able to take appropriate actions based on the information presented on the output device (312).

In Block 616, the maritime compliance detection system (300) may loop back to repeat the process at periodic intervals or aperiodic intervals and/or as requested by a terminal operator. The periodic monitoring of the terminal (100) may be used to maintain maritime compliance.

While the various blocks in FIG. 6 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

FIG. 7 depicts a method for maritime compliance detection, in accordance with one or more embodiments.

In Block 702, a raw application image (204) is acquired by the image capture device (202). The image capture device (202) is of high resolution, and of adequate frame rate, such that raw application images (204) are obtained by the image capture device (202) in real-time or near real-time. Any suitable camera that is capable of high resolution images and/or video in real-time, now known or later developed, may be employed for embodiments disclosed herein. In some embodiments, the image capture device (202) is mounted to a fixed location in a terminal (100). In other embodiments, the image capture device (202) may be located remotely from the terminal (100). For example, the image capture device (202) may be mounted on a moving vessel (102).

In Block 704, the raw application images (204) acquired by the image capture device (202) undergo processing by the image processing component (304). In some embodiments, processing may include background subtraction. In such embodiment, the image processing component (304) compares the raw application images (204) to a reference or background image and uses image subtraction to obtain a background-subtracted image and identifies pixels that may have changed between the two images. As such, a ROI can be formed, and the procedures described in this disclosure to determine maritime compliance may be applied to the ROI. In other embodiments, processing of the raw application images (204) may include normalizing the images. Additional techniques such as denoising, filtering, and aggregating multiple images, or other methods designed to reduce noise in the raw application images (204) and increase the quality of the raw application images (204) may be employed. Further, in some embodiments, processing of the raw application images (204) may not be required. The output of the image processing component (304) is a processed image.

In Block 706, the processed image and/or a part of the processed image (e.g., a ROI) is input into the trained ML network (307). In one or more embodiments, the ML network (307) is trained using the set of training images (316) and their associated class (318) and compliance labels (320). ML network (307) types may include, but are not limited to, generalized linear networks, Bayesian regression, random forests, and deep networks such as neural networks, convolutional neural networks, and vision transformers. The ML network (307) may be composed of multiple ML networks, acting in coordination or independently. In the case of multiple ML networks, these networks may be ensembled together or each network may be responsible for producing a specific output. Additionally, the ML network (307) is executed on the computer system (301), where the computer system (301) may be like that depicted and described with reference to FIG. 8 below. The computer system (301) can interact with a database (303) to store images in the image storage component (322). In accordance with one or more embodiments, the ML network (307) used in the maritime compliance detection system (300) disclosed herein is a CNN such as, for example, YOLO. Further, in some embodiments, the architecture of the CNN may be similar to the architecture of the residual neural network ResNet50.

In Block 708, the ML network (307) is used to detect, identify, label, count, and classify the features (e.g., objects, such as maritime compliance elements, and/or people) present in the processed image and/or a part of the processed image (e.g., a ROI). Detection indicates the location of a feature in a processed image. The location of a feature may be indicated using a bounding box that circumscribes the portion of the processed image containing the feature or the location of a feature may be indicated pixelwise, where each pixel which is found to be associated with a feature is flagged or given an identifier (i.e., instance segmentation). Many ML network (307) architectures are described in the literature for the task of object detection and identification. These ML networks are usually based on one or more CNNs.

As noted, the objective of the ML network (307) is to detect and classify instances of features. In Block 710, detected features are classified by the ML network (307). For each detected feature, a class probability distribution is returned. The class probability distribution indicates the probability that a feature belongs to each class in a given set of classes (e.g., class labels (318)). For example, each feature (e.g., objects, such as maritime compliance elements, and/or people) may be classified according to a set of classes including the classes {‘vessel’, ‘buoy’, ‘SPM buoy’, ‘life jacket’, ‘lifebuoy’, ‘lifeboat’, ‘life raft’, ‘immersion suit’, ‘PPE’, ‘people’, etc.}. Thus, the ML network (307) returns, at least, the location and class distribution of detected features in the processed image.

In Block 712, the ML network (307) determines a compliance state for each feature. The compliance state can be binary such as “compliant” or “non-compliant,” or multinomial such as “compliant,” “non-compliant,” or “compliance undetermined.” Further, in one or more embodiments, the ML network (307) may further specify the type of non-compliance. For example, in accordance with one or more embodiments, the ML network (307) may determine if the features are compliant with maritime and safety (e.g., HSE) regulations by comparing each feature against a ruleset such as the use cases previously described (and other ones not described). In one or more embodiments, the ML network (307) may further output an annotated version of the one or more processed images that labels all visible features and indicates the location of non-compliant features, if any. For example, the ML network (307) may determine if the location of any vessels (102), buoys, pilots, crew personnel, and drones in the terminal (100) is in violation of maritime compliance regulations. As such, an output of the ML network (307) is a determination of the set of classes (where a class identifies and/or describes a feature), quantity of each class, and a count of how many features in the processed image are compliant and non-compliant, without the need for a terminal operator to manually inspect for any maritime compliance violations.

Keeping with Block 712, in accordance with one or more embodiments, the ML network (307) performs pose estimation and face detection of people present in the processed image. Information obtained from a pose estimation algorithm allows the maritime compliance detection system (300) to determine the body posture of people in the terminal (100). In some embodiments, pose estimation may be used to detect “Man overboard!” situations. Further, in accordance with one or more embodiments, the ML network (307) may determine if a person in the terminal (100) is not properly wearing safety equipment (e.g., PPE).

In Block 714, the ML network (307) can issue a command or control signal to an external system or process using the communication equipment (310). For example, the control signal may generate an alarm or notification to a user that one or more detected features (e.g., objects, such as maritime compliance elements, and/or people) have been determined to be non-compliant by the maritime compliance detection system (300). In such an embodiment, the communication equipment (310) may transmit the control signal to an output device (312) (e.g., a web-based dashboard) that presents alerts (e.g., a visual warning) to terminal operators in real-time.

Embodiments disclosed herein may be implemented on a computer system. FIG. 8 is a block diagram of a computer system (802) used to provide computational functionalities associated with described algorithms, methods, functions, processes, flows, and procedures as described in the instant disclosure, according to one or more embodiments. For example, the ML-based image recognition subsystem (302) of the maritime compliance detection system (300) can include, or can be, a computer system (802) such as that depicted in FIG. 8. The illustrated computer (802) is intended to encompass any computing device such as a server, desktop computer, laptop/notebook computer, wireless data port, smart phone, personal data assistant (PDA), tablet computing device, one or more processors within these devices, or any other suitable processing device such as an edge computing device, including both physical or virtual instances (or both) of the computing device. An edge computing device is a dedicated computing device that is, typically, physically adjacent to the process or control with which it interacts.

Additionally, the computer (802) may include a computer that includes an input device, such as a keypad, keyboard, touch screen, or other device that may accept user information, and an output device that conveys information associated with the operation of the computer (802), including digital data, visual, or audio information (or a combination of information), or a GUI.

The computer (802) may serve in a role as a client, network component, a server, a database or other persistency, or any other component (or a combination of roles) of a computer system for performing the subject matter described in the instant disclosure. In some implementations, one or more components of the computer (802) may be configured to operate within environments, including cloud-computing-based, local, global, or other environment (or a combination of environments).

At a high level, the computer (802) is an electronic computing device operable to receive, transmit, process, store, or manage data and information associated with the described subject matter. According to some implementations, the computer (802) may also include or be communicably coupled with an application server, e-mail server, web server, caching server, streaming data server, business intelligence (BI) server, or other server (or a combination of servers).

The computer (802) may receive requests over network (830) from a client application (for example, executing on another computer (802) and responding to the received requests by processing the said requests in an appropriate software application. In addition, requests may also be sent to the computer (802) from internal users (for example, from a command console or by other appropriate access method), external or third-parties, other automated applications, as well as any other appropriate entities, individuals, systems, or computers.

Each of the components of the computer (802) may communicate using a system bus (803). In some implementations, any or all of the components of the computer (802), both hardware or software (or a combination of hardware and software), may interface with each other or the interface (804) (or a combination of both) over the system bus (803) using an application programming interface (API) (812) or a service layer (813) (or a combination of the API (812) and service layer (813). The API (812) may include specifications for routines, data structures, and object classes. The API (812) may be either computer-language independent or dependent and refer to a complete interface, a single function, or even a set of APIs. The service layer (813) provides software services to the computer (802) or other components (whether or not illustrated) that are communicably coupled to the computer (802). The functionality of the computer (802) may be accessible for all service consumers using this service layer. Software services, such as those provided by the service layer (813), provide reusable, defined business functionalities through a defined interface. For example, the interface may be software written in JAVA, C++, or other suitable language providing data in extensible markup language (XML) format or another suitable format. While illustrated as an integrated component of the computer (802), alternative implementations may illustrate the API (812) or the service layer (813) as stand-alone components in relation to other components of the computer (802) or other components (whether or not illustrated) that are communicably coupled to the computer (802). Moreover, any or all parts of the API (812) or the service layer (813) may be implemented as child or sub-modules of another software module, enterprise application, or hardware module without departing from the scope of this disclosure.

The computer (802) includes an interface (804). Although illustrated as a single interface (804) in FIG. 8, two or more interfaces (804) may be used according to particular needs, desires, or particular implementations of the computer (802). The interface (804) is used by the computer (802) for communicating with other systems in a distributed environment that are connected to the network (830). Generally, the interface (804) includes logic encoded in software or hardware (or a combination of software and hardware) and operable to communicate with the network (830). More specifically, the interface (804) may include software supporting one or more communication protocols associated with communications such that the network (830) or interface's hardware is operable to communicate physical signals within and outside of the illustrated computer (802).

The computer (802) includes at least one computer processor (805). Although illustrated as a single computer processor (805) in FIG. 8, two or more processors may be used according to particular needs, desires, or particular implementations of the computer (802). Generally, the computer processor (805) executes instructions and manipulates data to perform the operations of the computer (802) and any algorithms, methods, functions, processes, flows, and procedures as described in the instant disclosure.

The computer (802) also includes a memory (806) that holds data for the computer (802) or other components (or a combination of both) that may be connected to the network (830). The memory may be a non-transitory computer readable medium. For example, memory (806) may be a database storing data consistent with this disclosure. Although illustrated as a single memory (806) in FIG. 8, two or more memories may be used according to particular needs, desires, or particular implementations of the computer (802) and the described functionality. While memory (806) is illustrated as an integral component of the computer (802), in alternative implementations, memory (806) may be external to the computer (802).

The application (807) is an algorithmic software engine providing functionality according to particular needs, desires, or particular implementations of the computer (802), particularly with respect to functionality described in this disclosure. For example, application (807) may serve as one or more components, modules, applications, etc. Further, although illustrated as a single application (807), the application (807) may be implemented as multiple applications (807) on the computer (802). In addition, although illustrated as integral to the computer (802), in alternative implementations, the application (807) may be external to the computer (802).

There may be any number of computers (802) associated with, or external to, a computer system containing computer (802), wherein each computer (802) communicates over network (830). Further, the term “client,” “user,” and other appropriate terminology may be used interchangeably as appropriate without departing from the scope of this disclosure. Moreover, this disclosure contemplates that many users may use one computer (802), or that one user may use multiple computers (802).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method of training a machine learning (ML) network comprising:
obtaining a plurality of training images, each comprising one or more labeled features; and
training, using the plurality of training images, the ML network to predict the one or more labeled features in a raw application image, wherein training comprises, for each image in the plurality of training images:
predicting, using the ML network, one or more candidate labeled features from the image,
forming a metric measuring a mismatch of the one or more candidate labeled features and the one or more labeled features,
updating the ML network based, at least in part, on finding an extremum of the metric, and
forming a trained ML network based, at least in part, on the update.

2. The method of claim 1, wherein the raw application image comprises a plurality of raw application images.

3. The method of claim 1, wherein the one or more candidate labeled features comprises one or more maritime compliance elements.

4. The method of claim 1, wherein the ML network comprises a convolutional neural network.

5. A method of determining maritime compliance comprising:
acquiring, using one or more image capture devices, a raw application image;
processing the raw application image to produce a processed image;
inputting the processed image into a trained ML network;
predicting one or more labeled features in the processed image using the trained ML network;
determining, with the trained ML network, a class of each of the one or more labeled features forming a set of determined classes;
determining, with the trained ML network, maritime compliance based, at least in part, on whether a first feature of the one or more labeled features is non-compliant based on the determined class of the first feature; and
generating one or more alerts regarding maritime compliance based on a determination that the first feature is non-compliant.

6. The method of claim 5, wherein the raw application image comprises a plurality of raw application images.

7. The method of claim 5, wherein at least one of the one or more alerts comprises a visual warning.

8. The method of claim 5, wherein the one or more labeled features comprises one or more maritime compliance elements.

9. The method of claim 5, wherein processing the raw application image comprises denoising and filtering the raw application image.

10. The method of claim 5, wherein the image capture device comprises a digital still camera or a digital video camera.

11. The method of claim 5,
wherein the one or more image capture devices are communicatively coupled to a trigger device,
wherein an image storage component stores the processed image in response to a trigger signal, and
wherein the trigger signal is generated by the trigger device in response to a non-compliant feature.

12. The method of claim 5, wherein processing comprises:
obtaining, from the one or more image capture devices, at least one background image;
subtracting the at least one background image from the raw application image to produce at least one background-subtracted image;
detecting pixels where the background-subtracted image changed from the raw application image;
identifying one or more object edges in the background-subtracted image; and
combining the one or more object edges to obtain a region of interest (ROI) in the background-subtracted image.

13. The method of claim 5, further comprising determining a closest point of approach between two or more labeled features based, at least in part, on the processed image.

14. The method of claim 5, wherein the ML network comprises a convolutional neural network.

15. The method of claim 5, further comprising obtaining a plurality of videos from the one or more image capture devices, wherein the image capture device comprises a time-lapse camera, a video camera, or a combination thereof.

16. A system for maritime compliance detection, the system comprising:
one or more image capture devices configured to acquire a raw application image; and
a maritime compliance detection system in communication with the image capture device, the maritime compliance detection system comprising a processor and a memory, the memory storing instructions that, when executed by the processor, cause the processor to:
receive a raw application image;
process the raw application image to produce a processed image;
input the processed image into a trained ML network;
predict one or more labeled features in the processed image using the trained ML network;
determine, with the trained ML network, a class of each of the one or more labeled features forming a set of determined classes;
determine, with the trained ML network, maritime compliance based, at least in part, on whether a first feature of the one or more labeled features is non-compliant based on the determined class of the first feature; and
generate one or more alerts regarding maritime compliance based on a determination that the first feature is non-compliant.

17. The system of claim 16, wherein the raw application image comprises a plurality of raw application images.

18. The system of claim 16, wherein the one or more labeled features comprises one or more maritime compliance elements.

19. The system of claim 16, wherein the image capture device comprises a digital still camera or a digital video camera.

20. The system of claim 16,
wherein the one or more image capture devices are communicatively coupled to a trigger device,
wherein an image storage component stores the processed image in response to a trigger signal, and
wherein the trigger signal is generated by the trigger device in response to a non-compliant feature.
